(19) United States
(12) Patent Application Publication
(10) Pub. No.: US 2021/0334719 A1
(43) Pub. Date: Oct. 28, 2021

(54) POWER TRANSMISSION/RECEPTION MANAGEMENT APPARATUS AND COMPUTER-READABLE STORAGE MEDIUM

(71) Applicant: HONDA MOTOR CO.,LTD., Tokyo (JP)

(72) Inventors: Motoki HISHIDA, Saitama (JP); Hakaru SADANO, Saitama (JP); Hiroyuki KANAZAWA, Saitama (JP)

(21) Appl. No.: 17/371,120

(22) Filed: Jul. 9, 2021

Related U.S. Application Data
(63) Continuation of application No. PCT/JP2019/001212, filed on Jan. 17, 2019.

(51) Int. Cl. G06Q 10/06; G06Q 10/10; B60L 53/18; G01C 21/28

(52) U.S. Cl. CPC G06Q 10/06312; G06Q 10/1093; G06Q 50/06; G01C 21/28; B60L 53/18

(57) ABSTRACT

Provided is a power transmission/reception management apparatus comprising: a storage unit configured to store information indicating a correspondence between a scheduled period during which a vehicle provided with a driving electric power source is enabled to transmit and receive power with a power grid, and the vehicle; and a control unit configured to cause, when the vehicle is not enabled to transmit or receive power with the power grid at a predetermined time point earlier than the scheduled period, a notification to be given to a user correlated with the vehicle.

### CROSS REFERENCE TO RELATED APPLICATION

The contents of the following international patent application are incorporated herein by reference,

International Application NO. PCT/JP2019/001212 filed on Jan. 17, 2019.

### BACKGROUND

### 1. Technical Field

The present invention relates to a power transmission/reception management apparatus and a computer-readable storage medium.

### 2. Related Art

Regarding charge of an electric vehicle, there is known a technology to notify a subscriber that the charge has not been carried out at a charge station (see the below Patent Document 1 or the like, for example).

### PRIOR ART DOCUMEN

### Patent Document

Patent Document 1: Japanese Patent No. 5432292.

Patent Document 2: Japanese Patent Application Publication No. 2017-028787.

### BRIEF DESCRIPTION OF THE DRAWINGS

FIG. 1 schematically shows a basic configuration of a power transmission/reception system 100.

FIG. 2 schematically shows a functional configuration of a management server 40.

FIG. 3 shows an example of a screen 300 for setting a scheduled period to connect a vehicle 30 to a charge/discharge facility 20.

FIG. 4 shows an example of schedule information in a table form.

FIG. 5 shows an example of history information indicating a location history of the vehicle 30 in a table form.

FIG. 6 describes processing of determining, based on the history information, whether to transmit a connection confirmation notification.

FIG. 7 is a flowchart showing a processing related to the transmission of the connection confirmation notification.

FIG. 8 schematically shows interaction when a user 80 other than a user of the vehicle 30 connects the vehicle 30 to the charge/discharge facility 20.

FIG. 9 is a flowchart showing processing when the user 80 other than the user of the vehicle 30 connects the vehicle 30 to the charge/discharge facility 20.

FIG. 10 shows an example of a computer 2000 in which a plurality of embodiments of the present invention may be entirely or partially embodied.

### DESCRIPTION OF EXEMPLARY EMBODIMENTS

Hereinafter, the present invention will be described through embodiments of the invention, but the following embodiments do not limit the claimed invention. Moreover, not all combinations of features described in the embodiments are necessary to solutions of the invention. Note that, in the drawings, the same reference numbers may be given to the same or similar parts to omit duplicated description.

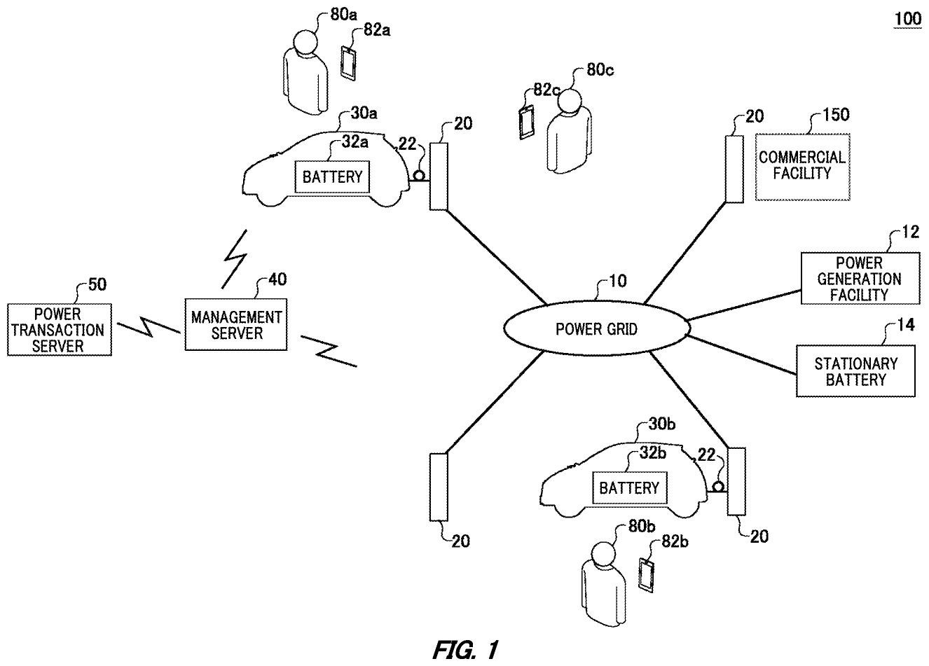

FIG. 1 schematically shows a basic configuration of a power transmission/reception system 100. The power transmission/reception system 100 is a system for a power aggregator, for example, to carry out V2G (Vehicle-to-Grid) for accommodating electric power between the vehicle and a power grid, by using a battery provided in a vehicle. The power transmission/reception system 100 has a function to facilitate connection of the vehicle to the power grid. Note that carrying out at least one of releasing electric power to the power grid by the vehicle and receiving electric power from the power grid by the vehicle is referred to as V2G

The power transmission/reception system 100 is provided with: a plurality of vehicles including a vehicle 30a and a vehicle 30b; a stationary battery 14; a plurality of charge/discharge facilities 20; a management server 40; a power generation facility 12; a plurality of user terminals including a user terminal 82a, a user terminal 82b, and a user terminal 82c.

A user 80a, a user 80b, and a user 80c are users of the power transmission/reception system 100. Specifically, the user 80a is a user of the vehicle 30a, and the user 80b is a user of the vehicle 30b. Note that a user of the vehicle may be any person who uses the vehicle, such as an owner of the vehicle or a family of the owner. The user 80c is neither a user of the vehicle 30a nor a user of the vehicle 30b. According to this embodiment, each of the users: the user 80a, the user 80b, and the user 80c, may be collectively referred to as “user 80”.

The vehicle 30a is provided with a battery 32a. The vehicle 30b is provided with a battery 32b. According to this embodiment, the plurality of vehicles including the vehicle 30a and the vehicle 30b may be collectively referred to as “vehicle 30”. Moreover, a plurality of batteries including the battery 32a and the battery 32b may be collectively referred to as “battery 32”.

Note that the battery 32 is an example of a driving electric power source provided in the vehicle 30. The driving electric power source includes an electric power source for generating electric energy to be provided to a power source of the vehicle 30 by consuming fuel, such as a fuel cell or the like. The fuel may be hydrogen, hydrocarbon fuel such as petrol, light oil, and natural gas, alcohol fuel, or the like. The driving electric power source may be any electric power source that can generate electric energy to be provided to the power source of the vehicle 30.

The vehicle 30 is an example of transportation equipment. The vehicle 30 is a vehicle provided with a power source driven by electric energy, such as, for example, an electric vehicle or a fuel cell vehicle (FCV). The electric vehicle includes a battery electric vehicle (BEV), and a hybrid vehicle or a plug-in hybrid electric vehicle (PHEV) provided with an internal-combustion engine that provides at least a part of power. According to this embodiment, the vehicle 30 is an electric vehicle provided with the battery 32 as a driving electric power source. In a form of adopting a battery as a driving electric power source, discharging the battery corresponds to releasing energy from the driving electric power source, and charging the battery corresponds to accumulating energy in the driving electric power source. Moreover, the remaining capacity of the battery corresponds to an amount of energy accumulated in the driving electric power source, such as an amount of power or an amount of electricity that can be supplied from the driving electric power source.

The user terminal 82a is a communication terminal used by the user 80a. The user terminal 82b is a communication terminal used by the user 80b. The user terminal 82c is a communication terminal used by the user 80c. The plurality of user terminals including the user terminal 82a, the user terminal 82b, and the user terminal 82c may be collectively referred to as “user terminal 82”.

The user terminal 82 may be, for example, a mobile terminal, a personal computer, a vehicle navigation apparatus, or the like. Examples of the mobile terminal can include a mobile phone, a smart phone, a PDA, a tablet, a notebook computer, a laptop computer, a wearable computer, and the like.

The management server 40 can communicate with the vehicle 30, the stationary battery 14, and the user terminal 82 through a communication network. The management server 40 can also communicate with a power transaction server 50 through a communication network. The communication network may include a transmission channel for wired communication or wireless communication. The communication network may include a communication system including the Internet, a P2P network, a dedicated line, a VPN, a power line communication line, a mobile phone line, or the like.

A power grid 10 may include a transmission system or a distribution system of an electric power system, and a transmission network of a power grid. The vehicle 30, the stationary battery 14, the charge/discharge facility 20, and the power generation facility 12 are connected to the power grid 10. The charge/discharge facility 20, the stationary battery 14, and the power generation facility 12 can transmit and receive power to and from the power grid 10.

The power generation facility 12 is managed by an electric power company or the like. The charge/discharge facility 20 includes, for example, a charger/discharger installed in a house, a charge/discharge stand installed in an apartment house, a parking place of a building or a commercial facility 150, a public space, or the like.

The vehicle 30 is connected to the charge/discharge facility 20 through a charge/discharge cable 22. That is, the vehicle 30 is connected to the power grid 10 through the charge/discharge cable 22 and the charge/discharge facility 20. The vehicle 30 transmits and receives power between the battery 32 and the power grid 10 through the charge/discharge facility 20. For example, the vehicle 30 releases electric power obtained by discharging the battery 32 to the power grid 10 via the charge/discharge cable 22 and the charge/discharge facility 20. Moreover, the vehicle 30 charges the battery 32 with electric power supplied from the power grid 10 via the charge/discharge cable 22 and the charge/discharge facility 20. Note that power transmission and reception to and from the power grid 10 may be referred to as “power transmission/reception with the power grid 10” or the like.

The stationary battery 14 is managed by the power aggregator. The battery 32 of the vehicle 30 forms a virtual power plant with the stationary battery 14. The management server 40 is managed by the power aggregator. The management server 40 controls power transmission/reception between the battery 32 and the power grid 10, and between the stationary battery 14 and the power grid 10.

The management server 40 conducts a power transaction by making a bid in a wholesale power market. The power transaction server 50 is managed by an operator of the wholesale power market. The management server 40 makes the bid to the power transaction server 50 by a time unit with 30 minutes as one frame. The management server 40 causes the battery 32 and the stationary battery 14 to be discharged in each frame based on a contract result, to supply electric power to the power grid 10.

For example, the management server 40 causes the battery 32 and the stationary battery 14 to be discharged according to a contract amount for the bid of the power aggregator in the wholesale power market, to supply the power grid 10 with electric power released from the battery 32 and the stationary battery 14. Moreover, the management server 40 controls charge and discharge of the battery 32 and the stationary battery 14 within a range of balancing control power contracted for the bid of the power aggregator in a supply/demand balancing market, to balance a power supply and demand in the power grid 10. For example, the management server 40 controls charge and discharge of the battery 32 and the stationary battery 14, in response to an increased demand response (increased DR), a decreased demand response (decreased DR), and an increased-and-decreased demand response (increased-and-decreased DR) from a power transmission/distribution company or a retail electricity supplier.

Specifically, in response to the increased DR, the management server 40 causes the battery 32 of the vehicle 30 to be charged with electric power received from the power grid 10 through the charge/discharge facility 20, by controlling at least one of the vehicle 30 and the charge/discharge facility 20. Moreover, in response to the decreased DR, the management server 40 causes the battery 32 of the vehicle 30 to be discharged by controlling at least one of the vehicle 30 and the charge/discharge facility 20, and causes electric power obtained by discharging the battery 32 to be released towards the power grid 10 through the charge/discharge facility 20.

According to this embodiment, the management server 40 obtains, from each user 80 of the vehicle 30, a scheduled period to connect the vehicle 30 to the charge/discharge facility 20. The management server 40 transmits a connection confirmation notification to the user 80 of the vehicle 30, when the vehicle 30 is not connected to the charge/discharge facility 20 at a predetermined time point earlier than the scheduled period. For example, if the user 80 plans to connect the vehicle 30 to the charge/discharge facility 20 after coming home from work, and can normally come home from work in 30 minutes, the connection confirmation notification is transmitted to the user 80 when the vehicle 30 is parked near the workplace 40 minutes before a starting time of the scheduled period. This can reduce a possibility of the user 80 being unable to connect the vehicle 30 to the charge/discharge facility 20, which facilitates the power aggregator to secure capacity of power that can be transmitted and received between the vehicle 30 and the power grid 10.

Note that, according to this embodiment, power transmission/reception means that electric power is delivered from at least one of the vehicle 30 and the power grid 10 to the other. For example, power transmission/reception may mean that electric power is released from the vehicle 30 towards the power grid 10. Moreover, power transmission/reception may mean that power is transmitted from the power grid 10 towards the vehicle 30. Note that, in case where electric power is released from the vehicle 30 through a charger/discharger installed at a power consumer's such as a home, when power consumption on the power consumer side is greater than the electric power released from the vehicle 30, there may occur no net power supply to the power grid 10 at a connection point between the power consumer side and the power grid 10, and there simply may be a decrease in an amount of power supplied from the connection point to the power consumer. Even in this case, when seen from the power grid 10, it can be considered that electric power has been transmitted and received to and from an outside of the power grid 10. Therefore, according to this embodiment, it does not matter whether the power grid 10 receives the net power from a specific connection point between the power grid 10 and the vehicle 30, during the power transmission/reception with the power grid 10 when electric power is released from the vehicle 30.

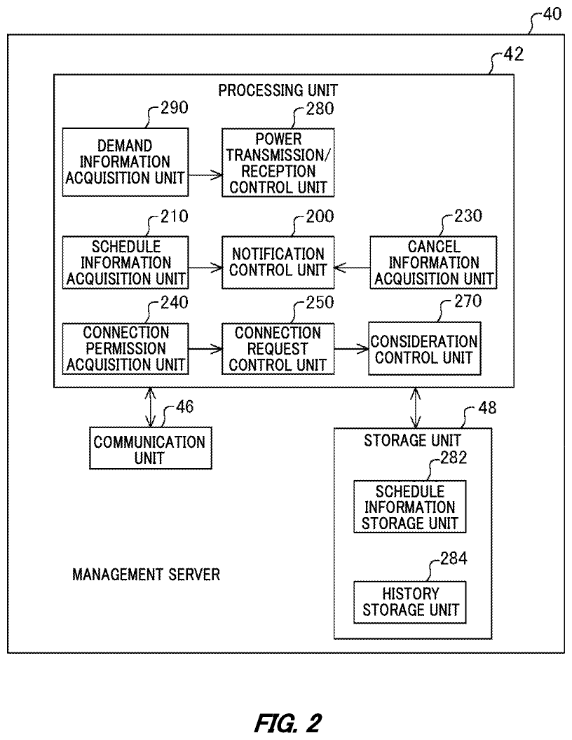

FIG. 2 schematically shows a functional configuration of the management server 40. The management server 40 is provided with a processing unit 42, a storage unit 48, and a communication unit 46.

The processing unit 42 is implemented by a processing apparatus including a processor. The storage unit 48 is implemented by a non-volatile storage apparatus. The processing unit 42 performs processing by using information stored in the storage unit 48. The communication unit 46 is responsible for communication to and from the vehicle 30, the stationary battery 14, the user terminal 82, and the power transaction server 50. Information received by the communication unit 46 from the vehicle 30, the stationary battery 14, the user terminal 82, and the power transaction server 50 is supplied to the processing unit 42. Moreover, information to be transmitted to the vehicle 30, the stationary battery 14, the user terminal 82, and the power transaction server 50 is generated by the processing unit 42 and transmitted via the communication unit 46.

The management server 40 serves as a power transmission/reception management apparatus. The management server 40 may be a system implemented by one information processing apparatus or may be a system implemented by a plurality of information processing apparatuses.

The processing unit 42 is provided with a schedule information acquisition unit 210, a notification control unit 200, a cancel information acquisition unit 230, a connection permission acquisition unit 240, a connection request control unit 250, a consideration control unit 270, a power transmission/reception control unit 280, and a demand information acquisition unit 290. The storage unit 48 is provided with a schedule information storage unit 282 and a history storage unit 284.

The schedule information storage unit 282 stores information indicating a correspondence between a scheduled period during which the vehicle 30 provided with the battery 32 is enabled to transmit and receive power with the power grid 10, and the vehicle 30. The notification control unit 200 causes a notification to be given to the user 80 correlated with the vehicle 30, when the vehicle 30 is not enabled to transmit or receive power with the power grid 10 at a predetermined time point earlier than the scheduled period. For example, the notification control unit 200 causes the notification to be given to the user 80 correlated with the vehicle 30, when the vehicle 30 is not connected to the charge/discharge facility 20 for transmitting and receiving power between the vehicle 30 and the power grid 10, at the predetermined time point earlier than the scheduled period. Specifically, the power transmission/reception control unit 280 transmits a connection confirmation notification to the user terminal 82 through the communication unit 46, when the vehicle 30 is not connected to the charge/discharge facility 20. Note that the charge/discharge facility 20 is an example of a power transmission/reception facility.

The notification control unit 200 may determine a time point to cause the notification to be given to the user 80, based on a current location of the vehicle 30, a location of the charge/discharge facility 20, and the scheduled period. The notification control unit 200 may determine the time point to cause the notification to be given to the user 80, based on the current location of the vehicle 30, a location information history of the vehicle 30, the location of the charge/discharge facility 20, and the scheduled period.

The notification control unit 200 may determine the time point to cause the notification to be given to the user 80, based on a plurality of reference travel patterns specified from the location information history of the vehicle 30, a current travel pattern of the vehicle 30, the location of the charge/discharge facility 20, and the scheduled period. Examples of the reference travel pattern can include a route on which the vehicle 30 travels between the workplace of the user 80 and the home of the user 80. If there is no reference travel pattern among the plurality of reference travel patterns that matches the current travel pattern of the vehicle 30 and whose destination has the charge/discharge facility 20, the notification control unit 200 may cause the notification to be given to the user 80 at an earlier time point.

The notification control unit 200 may specify a reference travel pattern among the plurality of reference travel patterns that matches the current travel pattern of the vehicle 30 and whose destination has the charge/discharge facility 20, and cause the notification to be given to the user 80 at a time point where a difference between the scheduled period and an estimated arrival time based on the specified reference travel pattern becomes shorter than a predetermined time difference.

The notification control unit 200 may specify one or more reference locations based on the location information history of the vehicle 30, and if the current location of the vehicle 30 is not within a predetermined range from the specified reference locations, the notification control unit 200 may cause the notification to be given to the user 80 at an earlier time point.

The notification control unit 200 may determine the time point to cause the notification to be given to the user 80, further based on a current location of the user 80. For example, the longer a distance between the user 80 and the vehicle 30 is, at the earlier time point the notification control unit 200 may cause the notification to be given to the user 80. If the current location of the user 80 is not within a predetermined range from the current location of the vehicle 30, the notification control unit 200 may cause the notification to be given to the user 80 at an earlier time point than a case where the current location of the user 80 is within the predetermined range from the current location of the vehicle 30. Thus, the notification control unit 200 may determine the time point to cause the notification to be given to the user 80, based on the current location of the user 80, the current location of the vehicle 30, the location of the charge/discharge facility 20, and the scheduled period.

Note that the notification control unit 200 may determine the time point to cause the notification to be given to the user 80, based on the current location of the user 80, the current location of the vehicle 30, and the scheduled period. For example, if the current location of the vehicle 30 is within a predetermined range from the location of the charge/discharge facility 20, the notification control unit 200 may determine the time point to cause the notification to be given to the user 80, based on the current location of the user 80, the current location of the vehicle 30, and the scheduled period. For example, the notification control unit 200 may cause the notification to be given to the user 80, when the vehicle 30 is not connected to the charge/discharge facility 20 at a time point earlier than the scheduled period by a time corresponding to a distance between the current location of the user 80 and the current location of the vehicle 30.

The notification control unit 200 may cause the notification to be given to the user 80, when the vehicle 30 is not connected to the charge/discharge facility 20 at a time point earlier than the scheduled period by a time predetermined by the user 80. For example, if “one hour” is set as “time predetermined” by the user 80, the notification control unit 200 may cause the notification to be given to the user 80, when the vehicle 30 is not connected to the charge/discharge facility 20 one hour before the starting time of the scheduled period.

The cancel information acquisition unit 230 obtains, from the user 80, cancel information indicating that a scheduled power transmission/reception between the vehicle 30 and the power grid 10 during the scheduled period is canceled. If the cancel information is obtained, the notification control unit 200 notifies a user 80 of another vehicle 30 to transmit and receive power to and from the power grid 10 during the scheduled period.

Note that the notification control unit 200 may cause the notification to be given to the user 80, when the vehicle 30 is not enabled to transmit or receive power with the power grid 10 at a time point earlier than the scheduled period where a predetermined time has passed since the user 80 got off the vehicle 30. For example, the notification control unit 200 may cause the notification to be given to the user 80, when the vehicle 30 is not connected to the charge/discharge facility 20 at a time point where 5 minutes have passed since the user 80 got off the vehicle 30.

Moreover, when a plurality of users 80 are correlated with the vehicle 30, the notification control unit 200 may cause a notification to be given more preferentially to the user 80 who is closer to the vehicle 30 and the charge/discharge facility 20. For example, in case where a user 80 commuting by the vehicle 30 is at work and the vehicle 30 normally used for commuting is exceptionally at home, when a family of the user 80 is at home, the notification control unit 200 may cause a notification to be given more preferentially to the family of the user 80 than to the user 80.

When the vehicle 30 is not connected to the charge/discharge facility 20 for transmitting and receiving power between the vehicle 30 and the power grid 10, at the predetermined time point earlier than the scheduled period, the connection request control unit 250 requests the user 80 other than the user of the vehicle 30, who can connect the vehicle 30 to the charge/discharge facility 20, to connect the vehicle 30 to the charge/discharge facility 20. The connection permission acquisition unit 240 obtains, from the user 80 of the vehicle 30, permission information that allows the user 80 other than the user of the vehicle 30 to connect the vehicle 30 to the charge/discharge facility 20. The connection request control unit 250 may request another user 80 to connect the vehicle 30 to the charge/discharge facility 20, on condition that the connection permission acquisition unit 240 has obtained the permission information.

When the vehicle 30 has been connected to the charge/discharge facility 20 by the user 80 who was requested for the connection by the connection request control unit 250, the consideration control unit 270 associates consideration information with that user 80. Note that a user 80 other than the user of the vehicle 30a may include the user 80b and the user 80c. Moreover, a user 80 other than the user of the vehicle 30b may include the user 80a and the user 80c.

The demand information acquisition unit 290 obtains information indicating a power demand in the power grid 10. According to the power demand in the power grid 10, the power transmission/reception control unit 280 causes the vehicle 30 to transmit and receive power to and from the power grid 10.

The power transmission/reception control unit 280 communicates with an ECU of the vehicle 30, to sequentially obtain power transmission/reception availability information indicating whether the vehicle 30 is connected to the charge/discharge facility 20 that can transmit and receive power with the power grid 10. When the vehicle 30 can transmit and receive power to and from the power grid 10, the power transmission/reception control unit 280 instructs the ECU provided in the vehicle 30 to charge and discharge the battery 32, according to the power demand obtained by the demand information acquisition unit 290. According to the instruction of the power transmission/reception control unit 280, the ECU of the vehicle 30 communicates with the charge/discharge facility 20, and controls a power converter of the vehicle 30 to charge the battery 32 through the charge/discharge facility 20 or release electric power obtained by discharging the battery 32. Note that the power transmission/reception control unit 280 may sequentially obtain, from the ECU of the vehicle 30, information indicating: an amount of power input from the charge/discharge facility 20 to the power converter during the charge of the battery 32; an amount of power output from the power converter to the charge/discharge facility 20 during the discharge of the battery 32; and an SOC (State of Charge) of the battery 32. Based on the information obtained from the ECU of the vehicle 30, the power transmission/reception control unit 280 may control the power transmission/reception between the vehicle 30 and the power grid 10.

Note that the above-mentioned contract amount in the power transaction is an example of the information indicating a power demand. The information indicating a power demand may be a contract price in a power transaction, or a contract category indicating whether the contract is a buy contract or a sell contract. Moreover, the information indicating a power demand may be information indicating a real-time imbalance amount between supply and demand in the power grid 10, or may be information indicating a predicted value of an imbalance amount between supply and demand in the future. The information indicating a power demand may be information indicating a real-time power consumption of the power consumer of the power grid 10 or a predicted value of the power consumption. As the information indicating a power demand, it is possible to apply not only an amount of power itself, but also all kinds of information that directly or indirectly affects the power demand, such as temperature information, humidity information, weather information, or event information.

Note that examples of the power transaction market can include a transaction market such as a day-ahead market, an intraday market, and a supply/demand balancing market. As a transaction form of the power transaction, it is possible to apply various transaction forms other than transaction forms in these power transaction markets.

According to the management server 40, it is possible to give a prompt such that the user 80 can connect the vehicle 30 to the charge/discharge facility 20 during the scheduled period. This facilitates the power aggregator to secure the capacity of power that is transmitted and received between the vehicle 30 and the power grid 10, which consequently contributes to stabilization of the power grid 10.

Note that functions of the power transmission/reception management apparatus may be realized by the management server 40 alone, or may be realized by a combination of the management server 40 and the ECU of the vehicle 30. For example, at least a part of processing executed by the management server 40 may be executed by the ECU of the vehicle 30. For example, at least some of functions realized by the schedule information acquisition unit 210, the notification control unit 200, the cancel information acquisition unit 230, the connection permission acquisition unit 240, the connection request control unit 250, the consideration control unit 270, the power transmission/reception control unit 280, the demand information acquisition unit 290, schedule information storage unit 282, and the history storage unit 284 may be realized by the ECU of the vehicle 30.

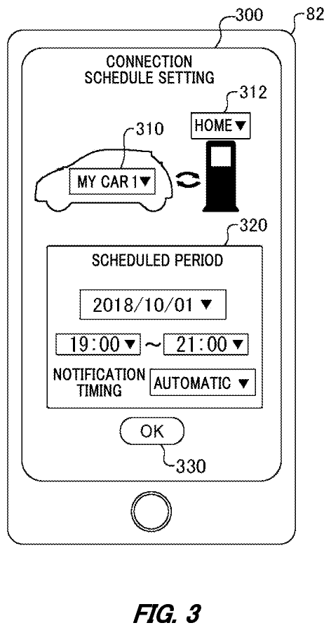

FIG. 3 shows an example of a screen 300 for setting the scheduled period to connect the vehicle 30 to the charge/discharge facility 20. The screen 300 is displayed on the user terminal 82 under control of the management server 40. The screen 300 includes a selection menu 310, a selection menu 312, an input menu 320 of the scheduled period, and an OK button 330.

The selection menu 310 is a menu for selecting a vehicle 30 to be connected to the charge/discharge facility 20. The input menu 320 is a menu for setting a scheduled connection date, a starting time of a scheduled connection time on the scheduled connection date, an ending time of the scheduled time, and notification timing. The scheduled period is determined by the scheduled connection date, the starting time, and the ending time. Note that it may be possible not only to set a specific date itself but also to set one or more days as the scheduled connection date, with information such as “weekdays”, “Saturdays and Sundays”, “Saturdays and holidays”, or “October”. It may be possible to set the starting time and the ending time of the scheduled connection time by any unit such as by a frame unit of 30 minutes or by the hour. The notification timing indicates how many hours before the starting time of the scheduled connection period a notification is to be given to the user 80. It may be possible to select the notification timing among, for example, “automatic”, “10 minutes before”, “30 minutes before”, “one hour before”, and the like. When “automatic” is selected, the management server 40 dynamically determines the notification timing based on the current location of the vehicle 30, the location of the charge/discharge facility 20, the current location of the user 80, and the like.

The selection menu 312 is a menu for selecting the charge/discharge facility 20 to which the vehicle 30 is to be connected. An option of the charge/discharge facility 20 to be the connection destination may be registered in the user terminal 82 in advance. Moreover, the user terminal 82 may obtain, from the management server 40, a history of a plurality of charge/discharge facilities 20 to which the vehicle 30 has been connected, and present, in the selection menu 312, one or more charge/discharge facilities 20 among the plurality of charge/discharge facilities 20, as the option of the charge/discharge facility 20 to be the connection destination.

When the user 80 presses the OK button 330, the user terminal 82 transmits, to the management server 40, identification information of the user 80, identification information of the vehicle 30, information indicating the scheduled period, and identification information of the charge/discharge facility 20 to be the connection destination. In the management server 40, the schedule information acquisition unit 210 stores, in the schedule information storage unit 282, the identification information of the vehicle 30, the information indicating the scheduled period, and the identification information of the charge/discharge facility 20 to be the connection destination that are transmitted from the user terminal 82, in association with the identification information of the user 80.

Note that the user 80 may access the management server 40 with the user terminal 82, to set by himself/herself the scheduled period and the charge/discharge facility 20 to be the connection destination. Moreover, the schedule information acquisition unit 210 may determine a scheduled period and a charge/discharge facility 20 to present to the user 80, based on the power demand obtained by the demand information acquisition unit 290 and a travel history of the user 80 or the vehicle 30, transmit information indicating the determined scheduled period and identification information of the determined charge/discharge facility 20 to the user terminal 82 by push notification, and cause the user 80 to select whether to accept a connection of the vehicle 30 to the charge/discharge facility 20 during the presented scheduled period, to thereby obtain information on the scheduled period and the charge/discharge facility 20 to be the connection destination.

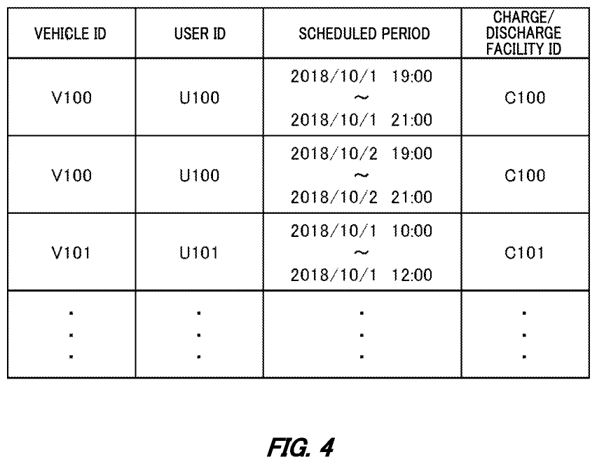

FIG. 4 shows an example of schedule information in a table form. The schedule information is stored in the schedule information storage unit 282 in the storage unit 48. The schedule information associates information indicating a vehicle ID, a user ID, a scheduled period, and a charge/discharge facility ID with one another.

For the vehicle ID, is stored identification information of the vehicle 30. For the vehicle ID, may be stored identification information of the vehicle 30 set by the user 80 through the screen 300 shown in FIG. 3 or the like. For the user ID, is stored identification information of the user 80. For the scheduled period, is stored information indicating a scheduled period to connect the vehicle 30 of the user 80 to the charge/discharge facility 20. For the scheduled period, may be stored information indicating a scheduled period set by the user 80 through the selection menu 310 of the screen 300 shown in FIG. 3 or the like. For the charge/discharge facility ID, is stored identification information of the charge/discharge facility 20 to which the vehicle 30 is to be connected. For the charge/discharge facility ID, may be stored identification information of the charge/discharge facility 20 to be the connection destination, selected by the user 80 through the selection menu 312 of the screen 300 shown in FIG. 3 or the like.

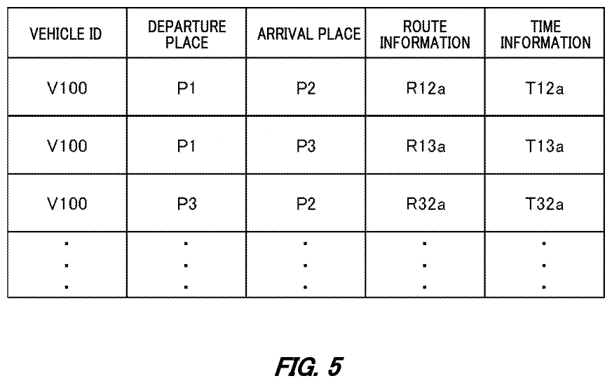

FIG. 5 shows an example of history information indicating a location history of the vehicle 30 in a table form. The history information is stored in the storage unit 48. The history information associates a vehicle ID, a departure place, an arrival place, route information, and time information with one another.

For the vehicle ID, is stored identification information of the vehicle 30. For the departure place, is stored information indicating a travel starting location of the vehicle 30. For the arrival place, is stored information indicating a travel ending location of the vehicle 30. For the route information, is stored information indicating a travel route of the vehicle 30 from the departure place to the arrival place. For the route information, may be stored node information on the travel route and link information connecting the nodes. For the time information, is stored information indicating time on the travel route of the vehicle 30 from the departure place to the arrival place. For example, for the time information, is stored a departure date and time, a date and time when the vehicle 30 has passed through the node on the travel route, and an arrival date and time.

The departure place, the arrival place, and the route information are examples of information indicating a travel pattern of the vehicle 30. The notification control unit 200 specifies a typical reference route of the vehicle 30 for each hour of the day based on the departure place, the arrival place, and the route information that are stored in the history storage unit 284 as well as on the time information. Assuming that the vehicle 30 travels according to a reference route, the notification control unit 200 transmits a connection confirmation notification at a time point where the vehicle 30 estimates arrival time to the charge/discharge facility 20 and a difference between the scheduled period and the estimated arrival time becomes less than a predetermined time.

Note that the history information shown in FIG. 5 is an example of information indicating the location history of the vehicle 30. For example, the history storage unit 284 may store time-series location data obtained by associating a geographical location of the vehicle 30 instead of the route information with the date and time.

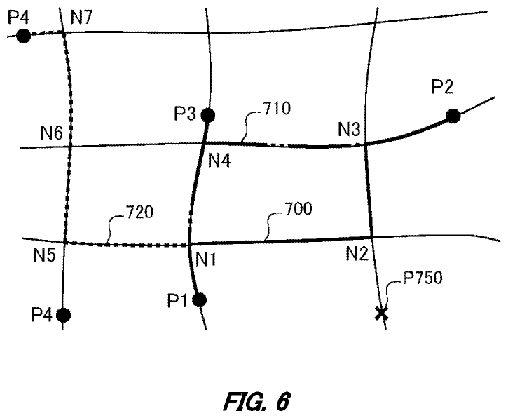

FIG. 6 describes processing of determining, based on the history information, whether to transmit a connection confirmation notification. In FIG. 6, it is assumed that P1 indicates a location of the workplace of the user 80, and P2 indicates a location of the home of the user 80. It is assumed that the charge/discharge facility 20 is provided at the home of the user 80.

For example, it is assumed that, as history information for the past half year associated with the identification information of the user 80, the history storage unit 284 stores a predetermined or larger number of routes 700 for the evening hours on weekdays, that are passing through a node N1, a node N2, and a node N3 in this order to reach the arrival place P2 from the departure place P1. Moreover, it is assumed that, as history information for the past half year associated with the identification information of the user 80, the history storage unit 284 stores a predetermined or larger number of routes 710 for the evening hours on weekdays, that are passing through the node N1 and a node N4 in this order to reach an arrival place P3 from the departure place P1 and that are passing through the node N4 and the node N3 in this order to reach the arrival place P2 from the departure place P3, 20 minutes after the arrival at P3. Moreover, it is assumed that, as history information for the past half year associated with the identification information of the user 80, the history storage unit 284 stores a predetermined or larger number of routes 720 for the evening hours on weekdays, that are passing through the node N1, a node N5, a node N6, and a node N7 in this order to reach an arrival place P4 from the departure place P1. Note that it is assumed that an average time required for the routes 700 is 30 minutes and an average time required for the routes 710 is 50 minutes.

Since the route 700, the route 710, and the route 720 are routes stored in the history information by a predetermined number or more, they can be each considered as a reference route that is a typical route as the travel route of the vehicle 30. Moreover, P1 and P3 are each a departure place on the reference route or a departure place of a route included in the reference route. Therefore, P1 and P3 can be each considered as a reference location that is a typical location as the location of the vehicle 30.

When the current location of the vehicle 30 is in a parking place near P1, the notification control unit 200 transmits no connection confirmation notification to the user 80 until 40 minutes before the starting time of the scheduled period. The notification control unit 200 transmits a connection confirmation notification to the user terminal 82 at a time point where there are less than 40 minutes left before the starting time of the scheduled period. “40 minutes before” that determines the time point to transmit the connection confirmation notification is determined from a value obtained by adding 10 minutes, which is a predetermined extension time, to 30 minutes, which is the shorter value of the average times required for the reference route 700 and the reference route 710 that are starting from P1. Thus, when the current location of the vehicle 30 is within a predetermined range from the reference location, the notification control unit 200 can transmit the connection confirmation notification to the user 80 at timing shortly before he/she misses the starting time of the scheduled period for the connection to the charge/discharge facility 20. This can reduce the number of connection confirmation notifications that are transmitted to the user 80, and can accordingly prevent the user 80 from feeling bothered by the connection confirmation notification.

On the other hand, when the current location of the vehicle 30 is at P4 that is away from P1, the notification control unit 200 calculates a time required to travel from P4 to P2, and transmits the connection confirmation notification to the user terminal 82 at a time point where it is determined that the vehicle 30 cannot travel to P2 no later than 30 minutes before the starting time of the scheduled period. Thus, if the user 80 is at a different location from usual, the connection confirmation notification can be transmitted to the user 80 at an earlier time point. This can prevent the user 80 from forgetting to connect the vehicle 30 to the charge/discharge facility 20 even if a pattern of activity of the user 80 is different from his/her usual pattern of activity.

Moreover, if the vehicle 30 is traveling on a link different from a link connecting the node N2 and the node N3 after departing from P1 and passing through the node N1 and the node N2, the notification control unit 200 may determine that the travel route of the vehicle 30 is deviated from the reference route 700, to transmit the connection confirmation notification to the user terminal 82, at a time point where the vehicle 30 reaches a point 750 that is away from the node N2 by a predetermined distance.

Note that, if the vehicle 30 is traveling on the route 720 after departing from P1, when the charge/discharge facility 20 is installed at the arrival place P4 of the route 720 and it is predicted that the vehicle 30 can arrive at the arrival place P4 before the starting time of the scheduled time, the notification control unit 200 does not have to transmit the connection confirmation notification to the user terminal 82, on condition that the charge/discharge facility 20 installed at P4 and the charge/discharge facility 20 installed at P2 can transmit and receive power to and from the same power grid 10. In this case, the notification control unit 200 may transmit the connection confirmation notification to the user terminal 82, when the vehicle 30 arrives at P4. Moreover, the notification control unit 200 may transmit the connection confirmation notification to the user terminal 82, when a predetermined time has passed without the vehicle 30 being connected to the charge/discharge facility 20 after the vehicle 30 arrives at P4. For example, the notification control unit 200 may transmit the connection confirmation notification to the user terminal 82, when 5 minutes have passed with no connection to the charge/discharge facility 20 since the user 80 got off the vehicle 30.

Note that, after the notification control unit 200 transmits the connection confirmation notification to the user terminal 82, if the cancel information acquisition unit 230 receives from the user 80 the fact that the connection to the charge/discharge facility 20 is canceled, the notification control unit 200 may notify the users 80 of a predetermined number of other vehicles 30 to connect to the charge/discharge facility 20. This allows the power aggregator to avoid shortage of an amount of power to be transmitted and received to and from the power grid 10.

Thus, according to the management server 40, if an activity of the user 80 is different from his/her usual activity, the connection confirmation notification can be transmitted early. This can prevent the user 80 from forgetting to connect the vehicle 30 to the charge/discharge facility 20.

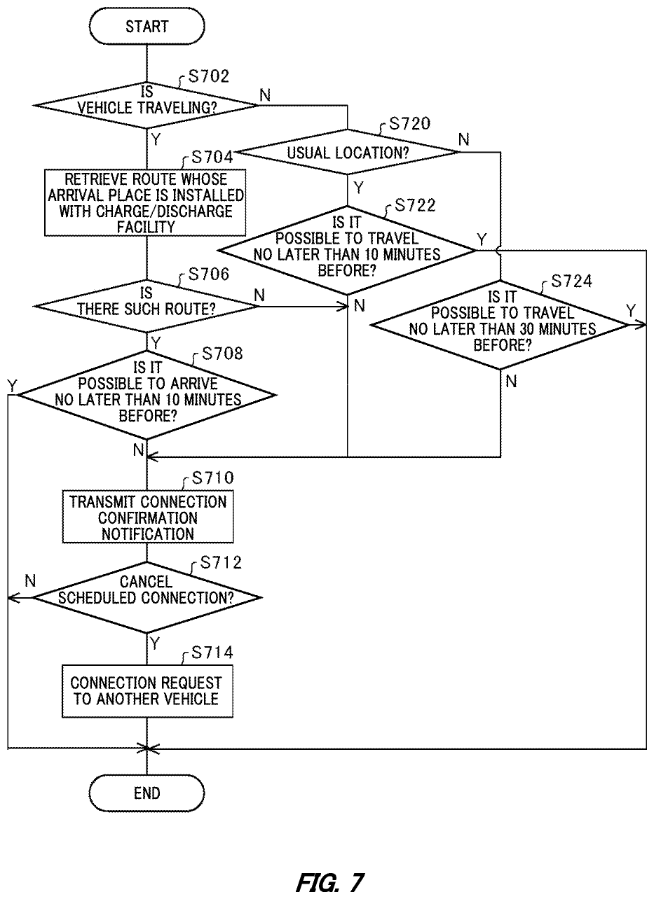

FIG. 7 is a flowchart showing a processing related to the transmission of the connection confirmation notification. The flowchart in FIG. 7 is mainly executed in the processing unit 42 of the management server 40. The processing of the flowchart in FIG. 7 is, for example, periodically executed in the management server 40.

In S702, the notification control unit 200 determines whether the vehicle 30 is traveling. If the vehicle 30 is traveling, in S704, with reference to the history information, a route whose arrival place is installed with the charge/discharge facility 20 is retrieved among reference routes associated with an hour of the day including a current time, and it is determined whether the route has been retrieved (S706). If the route has been retrieved, in S708, it is determined whether it is possible to arrive at the arrival place no later than 10 minutes before the starting time of the scheduled period.

If it is impossible to arrive at the arrival place no later than 10 minutes before the starting time of the scheduled period, in S710, the notification control unit 200 transmits the connection confirmation notification to the user terminal 82. For example, the notification control unit 200 transmits, to the user terminal 82, the connection confirmation notification including the starting time of the scheduled period. In S712, it is determined whether to cancel the scheduled connection of the vehicle 30 to the charge/discharge facility 20. For example, the cancel information acquisition unit 230 transmits, to the user terminal 82, an inquiry as to whether to cancel the scheduled connection, and if a cancel notification is obtained from the user terminal 82 in response to the transmission of the inquiry, the cancel information acquisition unit 230 determines that the scheduled connection of the vehicle 30 to the charge/discharge facility 20 during the scheduled period is canceled.

If the scheduled connection of the vehicle 30 to the charge/discharge facility 20 is canceled, in S714, the user 80 of another vehicle 30 is notified to connect to the charge/discharge facility 20. If the scheduled connection of the vehicle 30 to the charge/discharge facility 20 is not canceled, the processing of this flowchart is ended.

Moreover, in the determination in S708, if it is determined that the vehicle 30 can arrive at the arrival place no later than 10 minutes before the starting time of the scheduled period, the processing of this flowchart is ended with no connection confirmation notification being transmitted. Moreover, in S706, if there is no route retrieved whose arrival place is installed with the charge/discharge facility 20, the processing is shifted to S710, and the notification control unit 200 transmits the connection confirmation notification to the user terminal 82.

In the determination in S702, if it is determined that the vehicle 30 is not traveling, in S720, the notification control unit 200 determines whether the current location of the vehicle 30 is within a predetermined range from the reference location. If the current location of the vehicle 30 is within a predetermined range from the reference location, in S722, it is determined whether the vehicle 30 can travel to the charge/discharge facility 20 no later than 10 minutes before the starting time of the scheduled period. For example, as mentioned above, the notification control unit 200 determines whether the vehicle 30 can travel to the charge/discharge facility 20 no later than 10 minutes before, based on the shortest required time of times required for the reference routes starting from the current location.

If it is determined that it is impossible to travel to the charge/discharge facility 20 no later than 10 minutes before the starting time of the scheduled period, the processing is shifted to S710, the notification control unit 200 transmits the connection confirmation notification to the user terminal 82. If it is determined that it is possible to travel no later than 10 minutes before the starting time of the scheduled period, the processing of this flowchart is ended with no connection confirmation notification being transmitted.

In the determination in S720, if it is determined that the current location of the vehicle 30 is not within a predetermined range from the reference location, in S724, it is determined whether the vehicle 30 can travel to the charge/discharge facility 20 no later than 30 minutes before the starting time of the scheduled period. If the vehicle 30 cannot travel to the charge/discharge facility 20 no later than 30 minutes before the starting time, the processing is shifted to S710, and the notification control unit 200 transmits the connection confirmation notification to the user terminal 82. If the vehicle 30 can travel to the charge/discharge facility 20 no later than 30 minutes before the starting time, the processing of this flowchart is ended with no connection confirmation notification being transmitted.

Thus, if the current location of the vehicle 30 is in the vicinity of the reference location, an extension time to transmit the connection confirmation notification is decreased, and if the current location of the vehicle 30 is not in the vicinity of the reference location, the extension time is increased. This can prevent the user 80 from failing to connect the vehicle 30 to the charge/discharge facility 20 while preventing an unnecessary connection confirmation notification from being transmitted to the user 80.

Note that, in S722, the determination may be made further considering the current location of the user 80 and the current location of the vehicle 30. For example, the notification control unit 200 may determine whether the vehicle 30 can travel to the charge/discharge facility 20 no later than 10 minutes before the starting time of the scheduled period, based on how long it takes for the user 80 to travel from his/her current location to the current location of the vehicle 30 and the time required to travel from the current location of the vehicle 30 to the charge/discharge facility 20. Thus, the notification control unit 200 may determine the time point to transmit the connection confirmation notification, based on the current location of the user 80, the current location of the vehicle 30, the location of the charge/discharge facility 20, and the scheduled period.

FIG. 7 is a flowchart when “automatic” is selected as the notification timing through the selection menu 310 in FIG. 3. If a time other than “automatic” is selected as the notification timing, the notification control unit 200 may cause the connection confirmation notification to be transmitted, when the vehicle 30 is not connected to the charge/discharge facility 20 at a time point earlier than the starting time of the scheduled period by the time selected as the notification timing.

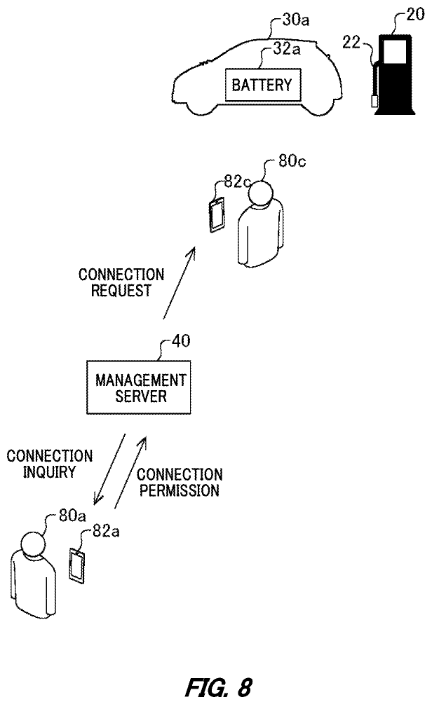

FIG. 8 schematically shows interaction when the user 80 other than the user of the vehicle 30 connects the vehicle 30 to the charge/discharge facility 20. In connection with FIG. 8, a description will be made by mentioning a case where the user 80c connects the vehicle 30a on behalf of the user 80a.

In FIG. 8, it is assumed that the vehicle 30a is parked in a parking place or the like without being connected to the charge/discharge facility 20. Moreover, it is assumed that the user 80a is away from the vehicle 30a and cannot immediately connect the vehicle 30a to the charge/discharge facility 20.

When the vehicle 30a is not connected to the charge/discharge facility 20 at a time point earlier than the starting time of the scheduled period to connect the vehicle 30a to the charge/discharge facility 20 by a predetermined time, and the user 80a is away from the vehicle 30a by a predetermined distance or longer, the notification control unit 200 transmits, to the user terminal 82a of the user 80a, inquiry information for inquiring whether another user may connect the vehicle 30a to the charge/discharge facility 20. When the user 80a performs, on the user terminal 82a, an operation to allow another user to connect the vehicle 30a to the charge/discharge facility 20, the user terminal 82a transmits connection permission information to the management server 40.

When the connection permission information is obtained from the user terminal 82, the connection request control unit 250 retrieves the user 80c who is near the vehicle 30a, to transmit, to the user terminal 82c, a connection request including token information for connecting the vehicle 30a to the charge/discharge facility 20. The token information is information for limiting the user 80 who is allowed to connect the vehicle 30a to the charge/discharge facility 20. As described later, the same token information is also transmitted to the vehicle 30a, and the vehicle 30a determines, from the token information, whether the user 80c is allowed to connect the vehicle 30a to the charge/discharge facility 20. Note that the connection request control unit 250 may include information for specifying the vehicle 30a in the connection request. Examples of the information for specifying the vehicle 30a can include a licence plate number of the vehicle 30a, an image of the vehicle 30a prestored in the storage unit 48, location information of the vehicle 30a, and the like. The connection request control unit 250 may cause the user 80c to recognize the vehicle 30a by causing the ECU of the vehicle 30a to flash a light emitting apparatus such as a turn indicator or a hazard flasher in a predetermined pattern. Note that the connection request control unit 250 also transmits, to the vehicle 30a, the same token information as the token information transmitted to the user terminal 82c.

When the user 80c brings the user terminal 82c closer to the vehicle 30a, the user terminal 82c transmits the token information to the ECU of the vehicle 30a by near field communication. When the token information received from the management server 40 matches the token information received from the user terminal 82c, the ECU of the vehicle 30a allows the charge/discharge cable 22 to be connected to the vehicle 30a. For example, the ECU of the vehicle 30a opens a lid of a charge/discharge cable attachment port of the vehicle 30a.

When the charge/discharge cable 22 detects that the charge/discharge cable 22 is attached to the charge/discharge cable attachment port of the vehicle 30a, the ECU of the vehicle 30a returns, to the management server 40, the token information received from the management server 40. When the token information is received from the vehicle 30a, the consideration control unit 270 generates, for the user 80c to whom the connection request including the token information was transmitted, consideration information indicating a consideration for the connection of the vehicle 30a to the charge/discharge facility 20, and associates the generated consideration information with the user 80c. For example, the consideration control unit 270 gives points to the user 80c.

This allows to have another user 80 make the connection even if the vehicle 30 is left without being connected to the charge/discharge facility 20 during the scheduled period, which can increase a probability for the vehicle 30 to be connected to the power grid 10.

Note that, in the description related to FIG. 8, it is assumed that the vehicle 30a is to be connected to the charge/discharge facility 20. However, even if the vehicle 30a is not to be connected to the charge/discharge facility 20, the vehicle 30a may be connected to the charge/discharge facility 20 by another user 80. For example, in case where the cancel information acquisition unit 230 obtains cancel information from the user 80b of the vehicle 30b, the notification control unit 200 may transmit the above-mentioned inquiry information to the user 80a, when notifying the user 80a to connect the vehicle 30a to the charge/discharge facility 20 during the scheduled time of the vehicle 30b.

In the example of FIG. 8, the description is made by mentioning the case where the user 80c connects the vehicle 30a to the charge/discharge facility 20, but the user 80b may also be another user who connects the vehicle 30a to the charge/discharge facility 20. Moreover, the user 80a and the user 80c may each be another user who connects the vehicle 30b to the charge/discharge facility 20.

It may be possible to use the points given to the user 80 as a cost for goods purchased at the commercial facility 150. Moreover, it may be possible to use the points given to the user 80 to charge the vehicle 30 with the stationary battery 14 in the event of emergency or disaster. For example, if the user 80 is given points equal to or more than a predetermined value, the processing unit 42 of the management server 40 may allow the charge of the battery 32 with the stationary battery 14 in exchange for subtracting a predetermined number of points from current points provided to the user 80, on condition that the remaining capacity of the battery 32 of the vehicle 30 of the user 80 is lower than a predetermined value.

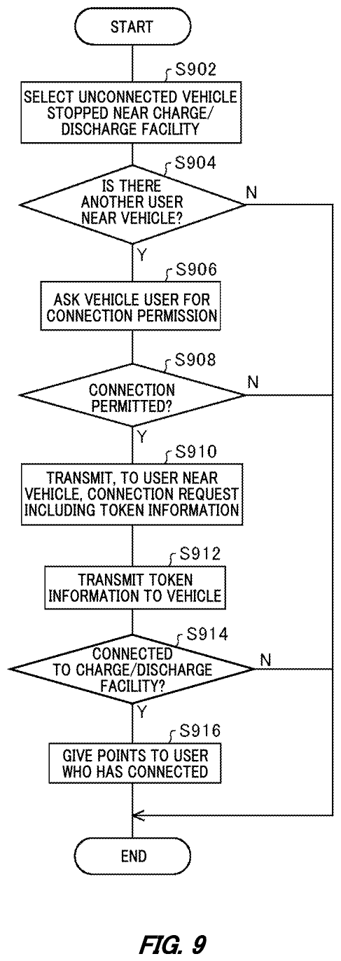

FIG. 9 is a flowchart showing processing when the user 80 other than the user of the vehicle 30 connects the vehicle 30 to the charge/discharge facility 20. The flowchart in FIG. 9 is mainly executed in the processing unit 42 of the management server 40. The processing of the flowchart in FIG. 9 is executed, for example, at a time point earlier than the starting time of the scheduled period during which the vehicle 30 transmits and receives power to and from the power grid 10, by a predetermined time.

In S902, the notification control unit 200 selects the vehicle 30 that is stopped near the charge/discharge facility 20 and that is not connected to the charge/discharge facility 20. In S904, the notification control unit 200 determines whether there is another user 80 near the vehicle 30. For example, the management server 40 registers in advance the user 80 who can connect the vehicle 30 other than his/her own vehicle to the charge/discharge facility 20. The notification control unit 200 determines whether there is another user 80 near the vehicle 30, based on location information obtained from the user terminal 82 of each user 80.

If there is another user 80 near the vehicle 30, in S906, the notification control unit 200 transmits, to the user terminal 82 of the user 80 of the vehicle 30, inquiry information as to whether the vehicle 30 may be connected by another user 80. In S908, the connection request control unit 250 determines whether connection permission information has been received from the user terminal 82 to which the inquiry information was transmitted. If the connection permission information has been received, in S910, the connection request control unit 250 transmits, to the user terminal 82 of the user 80 who is near the vehicle 30, a connection request including token information. In S912, the connection request control unit 250 transmits the token information to the vehicle 30.

In S914, the consideration control unit 270 determines whether the vehicle 30 has been connected to the charge/discharge facility 20. For example, if the vehicle 30 returns token information that matches the token information transmitted from the management server 40 to the vehicle 30 in S912, the consideration control unit 270 determines that the vehicle 30 has been connected to to the charge/discharge facility 20.

If it is determined, in the determination in S914, that the vehicle 30 has been connected to the charge/discharge facility 20, the consideration control unit 270 gives points to the user 80 of the user terminal 82 to whom the connection request was transmitted.

Note that if it is determined, in S904, that there is no other user 80 near the vehicle 30, the processing of this flowchart is ended. Moreover, if no connection permission information has been received in S908 from the user terminal 82 to which the inquiry information was transmitted, or if the vehicle 30 has not been connected to the charge/discharge facility 20 in S914, the processing of this flowchart is also ended.

According to the above-described power transmission/reception system 100, it is possible to prevent a situation where the vehicle 30 cannot be connected to the charge/discharge facility 20 during the scheduled period. This can lead more vehicles 30 to be connected to the power grid 10. This facilitates the power aggregator to secure the capacity of power that can be transmitted and received between the vehicle 30 and the power grid 10, which consequently contributes to stabilization of the power grid 10.

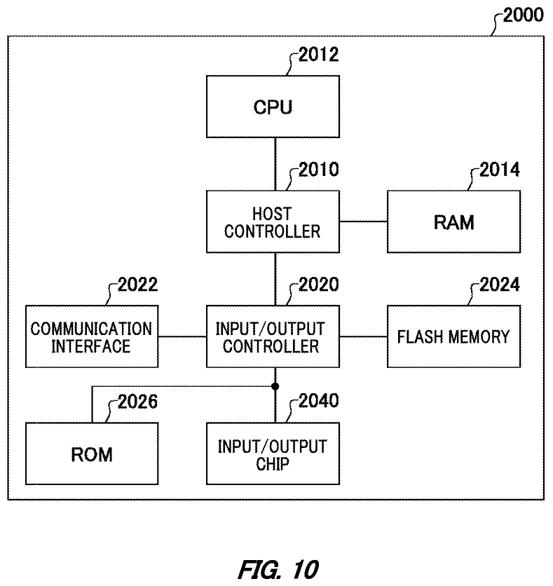

FIG. 10 shows an example of a computer 2000 in which a plurality of embodiments of the present invention may be entirely or partially embodied. A program installed in the computer 2000 can cause the computer 2000 to serve as an apparatus such as the management server 40 according to the embodiments or each unit of the apparatus, to execute operation correlated with the apparatus or each unit of the apparatus, and/or to execute a process according to the embodiments or a step of the process. Such a program may be executed by a CPU 2012 in order to cause the computer 2000 to execute a specific operation correlated with some or all of the processing procedures and the blocks in the block diagram described herein.

The computer 2000 according to this embodiment includes the CPU 2012 and RAM 2014, which are mutually connected by a host controller 2010. The computer 2000 also includes ROM 2026, a flash memory 2024, a communication interface 2022, and an input/output chip 2040. The ROM 2026, the flash memory 2024, the communication interface 2022 and the input/output chip 2040 are connected to the host controller 2010 via an input/output controller 2020.

The CPU 2012 operates according to the programs stored in the ROM 2026 and the RAM 2014, thereby controlling each unit.

The communication interface 2022 communicates with other electronic devices via a network. The flash memory 2024 stores the program and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via an input/output port such as a serial port, a parallel port, a keyboard port, a mouse port, a monitor port, a USB port, or an HDMI (registered trademark) port.

The programs are provided via a network or a computer-readable medium such as a CD-ROM, a DVD-ROM, or a memory card. The RAM 2014, the ROM 2026, or the flash memory 2024 is an example of the computer-readable medium. The programs are installed in the flash memory 2024, the RAM 2014 or the ROM 2026, and are executed by the CPU 2012. Information processing described in these programs is read by the computer 2000, and provides cooperation between the programs and the various types of hardwares resources described above. An apparatus or a method may be configured by realizing operation or processing of information according to a use of the computer 2000.

For example, when communication is performed between the computer 2000 and an external device, the CPU 2012 may execute a communication program loaded in the RAM 2014, and instruct the communication interface 2022 to execute communication processing, based on processing described in the communication program. The communication interface 2022, under control of the CPU 2012, reads transmission data stored in a transmission buffer processing region provided in a recording medium such as the RAM 2014 and the flash memory 2024, transmits the read transmission data to the network, and writes reception data received from the network into a reception buffer processing region or the like provided on the recording medium.

Moreover, the CPU 2012 may cause all or a necessary portion of a file or a database stored in the recording medium such as the flash memory 2024 or the like, to be read by the RAM 2014, and execute various types of processing on the data on the RAM 2014. Then, the CPU 2012 writes back the processed data into the recording medium.

Various types of programs and various types of information such as data, a table, and a database may be stored in the recording medium, and subjected to information processing. The CPU 2012 may execute, on the data read from the RAM 2014, various types of processing including various types of operations, information processing, conditional judgment, conditional branching, unconditional branching, information retrieval/replacement, or the like described herein and specified by instruction sequences of the programs, and writes back the results into the RAM 2014. Moreover, the CPU 2012 may retrieve information in a file, a database, or the like in the recording medium. For example, when a plurality of entries, each having an attribute value of a first attribute correlated with an attribute value of a second attribute, are stored in the recording medium, the CPU 2012 may retrieve, out of said plurality of entries, an entry with the attribute value of the first attribute specified that meets a condition, read the attribute value of the second attribute stored in said entry, and thereby obtain the attribute value of the second attribute correlated with with the first attribute meeting a predetermined condition.

The above-described programs or software module may be stored on the computer 2000 or in the computer-readable medium in the vicinity of the computer 2000. A recording medium such as a hard disc or RAM provided in a server system connected to a dedicated communication network or the Internet can be used as the computer-readable medium. The programs stored in the computer-readable medium may be provided to the computer 2000 via the network.

The program that is installed in the computer 2000 and that causes the computer 2000 to serve as the management server 40 may instruct the CPU 2012 or the like to cause the computer 2000 to serve as each unit of the management server 40. The information processing described in these programs are read by the computer 2000, thereby serving as the schedule information acquisition unit 210, the notification control unit 200, the cancel information acquisition unit 230, the connection permission acquisition unit 240, the connection request control unit 250, the consideration control unit 270, the power transmission/reception control unit 280, the demand information acquisition unit 290, the schedule information storage unit 282, and the history storage unit 284, which are specific means realized by the cooperation of software and the various types of hardware resources mentioned above. Then, these specific means realize operations or processing of information corresponding to the intended use of the computer 2000 according to this embodiment, so that the management server 40 is constructed as a specific management server corresponding to the intended use.

Various embodiments have been described with reference to the block diagram or the like. In the block diagram, each block may represent (1) a step of a process in which an operation is executed, or (2) each unit of the apparatus responsible for executing the operation. Specific steps and each unit may be implemented by a dedicated circuit, a programmable circuit supplied along with a computer-readable instruction stored on a computer-readable medium, and/or a processor supplied along with the computer-readable instruction stored on the computer-readable medium. The dedicated circuit may include a digital and/or analog hardware circuit, or may include an integrated circuit (IC) and/or a discrete circuit. The programmable circuit may include a reconfigurable hardware circuit including: logical AND, logical OR, logical XOR, logical NAND, logical NOR, and other logical operations; a memory element such as a flip-flop, a register, a field programmable gate array (FPGA), a programmable logic array (PLA), or the like; and so on.

The computer-readable medium may include any tangible device capable of storing an instruction executed by an appropriate device, so that the computer-readable medium having the instruction stored thereon constitutes at least a part of a product including an instruction that may be executed in order to provide a means to execute an operation specified by a processing procedure or a block diagram. Example of the computer-readable medium may include an electronic storage medium, a magnetic storage medium, an optical storage medium, an electromagnetic storage medium, a semiconductor storage medium, or the like. More specific examples of the computer-readable medium may include a floppy (registered trademark) disc, a diskette, a hard disc, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disc (DVD), a Blu-ray (registered trademark) disc, a memory stick, an integrated circuit card, and the like.

The computer-readable instruction may include: an assembler instruction, an instruction-set-architecture (ISA) instruction; a machine instruction; a machine dependent instruction; a microcode; a firmware instruction; state-setting data; or either a source code or a object code described in any combination of one or more programming languages, including an object oriented programming language such as Smalltalk (registered trademark), JAVA (registered trademark), C++, or the like; and a conventional procedural programming language such as a “C” programming language or a similar programming language.

The computer-readable instruction may be provided to a general-purpose computer, a special-purpose computer, or a processor or a programmable circuit of another programmable data processing apparatus, locally or via a local area network (LAN), a wide area network (WAN) such as the Internet or the like, and the computer-readable instruction may be executed in order to provide a means to execute operations specified by the described processing procedure or the block diagram. Examples of the processor include a computer processor, a processing unit, a microprocessor, a digital signal processor, a controller, a microcontroller, and the like.

While the embodiments of the present invention have been described, the technical scope of the invention is not limited to the above described embodiments. It is apparent to persons skilled in the art that various alterations and improvements can be added to the above-described embodiments. Moreover, to the extent that there is no technical contradiction, matters described for the specific embodiment can be applied to other embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: power grid

12: power generation facility

14: stationary battery

20: charge/discharge facility

22: charge/discharge cable

30: vehicle

32: battery

40: management server

42: processing unit

46: communication unit

48: storage unit

50: power transaction server

80: user

82: user terminal

100: power transmission/reception system

150: commercial facility

200: notification control unit

210: schedule information acquisition unit

230: cancel information acquisition unit

240: connection permission acquisition unit

250: connection request control unit

270: consideration control unit

280: power transmission/reception control unit

282: schedule information storage unit

284: history storage unit

290: demand information acquisition unit

300: screen

310: selection menu

312: selection menu

320: input menu

330: OK button

700: route

710: route

720: route

750: point

2000: computer

2010: host controller

2012: CPU

2014: RAM

2020: input/output controller

2022: communication interface

2024: flash memory

2026: ROM

2040: input/output chip

What is claimed is:

1. A power transmission/reception management apparatus comprising:
a storage unit configured to store information indicating a correspondence between a scheduled period during which a vehicle provided with a driving electric power source is enabled to transmit and receive power with a power grid, and the vehicle; and
a notification control unit configured to cause a notification to be given to a user correlated with the vehicle, when the vehicle is not enabled to transmit or receive power with the power grid at a predetermined time point earlier than the scheduled period.

2. The power transmission/reception management apparatus according to claim 1, wherein
the notification control unit is configured to cause the notification to be given to the user correlated with the vehicle, when the vehicle is not connected to a power transmission/reception facility for transmitting and receiving power between the vehicle and the power grid at the predetermined time point earlier than the scheduled period.

3. The power transmission/reception management apparatus according to claim 2, wherein
the notification control unit is configured to determine a time point to cause the notification to be given to the user, based on a current location of the vehicle, a location of the power transmission/reception facility, and the scheduled period.

4. The power transmission/reception management apparatus according to claim 2, wherein
the notification control unit is configured to determine the time point to cause the notification to be given to the user, based on a current location of the vehicle, a location information history of the vehicle, the location of the power transmission/reception facility, and the scheduled period.

5. The power transmission/reception management apparatus according to claim 2, wherein
the notification control unit is configured to determine the time point to cause the notification to be given to the user, based on a plurality of reference travel patterns specified from a location information history of the vehicle, a current travel pattern of the vehicle, the location of the power transmission/reception facility, and the scheduled period.

6. The power transmission/reception management apparatus according to claim 5, wherein
the notification control unit is configured to cause the notification to be given to the user at an earlier time point, if there is no reference travel pattern among the plurality of reference travel patterns that matches the current travel pattern of the vehicle and whose destination has the power transmission/reception facility.

7. The power transmission/reception management apparatus according to claim 5, wherein
the notification control unit is configured to:
specify a reference travel pattern among the plurality of reference travel patterns that matches the current travel pattern of the vehicle and whose destination has the power transmission/reception facility; and
cause the notification to be given to the user at a time point where a difference between the scheduled period and an estimated arrival time based on the specified reference travel pattern becomes shorter than a predetermined time difference.

8. The power transmission/reception management apparatus according to claim 4, wherein
the notification control unit is configured to:
specify one or more reference locations from the location information history of the vehicle; and
cause the notification to be given to the user at an earlier time point, if the current location of the vehicle is not within a predetermined range from the specified reference locations.

9. The power transmission/reception management apparatus according to claim 3, wherein
the notification control unit is configured to determine the time point to cause the notification to be given to the user, further based on a current location of the user.

10. The power transmission/reception management apparatus according to claim 2, wherein
the notification control unit is configured to determine the time point to cause the notification to be given to the user, based on a current location of the user, the current location of the vehicle, and the scheduled period.

11. The power transmission/reception management apparatus according to claim 2, wherein
the notification control unit is configured to cause the notification to be given to the user, when the vehicle is not connected to the power transmission/reception facility at a time point earlier than the scheduled period by a time predetermined by the user.

12. The power transmission/reception management apparatus according to claim 2, wherein
the notification control unit is configured to, when a plurality of users are correlated with the vehicle, cause a notification to be given more preferentially to a user who is closer to the vehicle and the power transmission/reception facility.

13. The power transmission/reception management apparatus according to claim 1, further comprising
a connection request control unit configured to, when the vehicle is not connected to the power transmission/reception facility for transmitting and receiving power between the vehicle and the power grid at the predetermined time point earlier than the scheduled period, request a person other than the user, who can connect the vehicle to the power transmission/reception facility, to connect the vehicle to the power transmission/reception facility.

14. The power transmission/reception management apparatus according to claim 1, further comprising
a cancel information acquisition unit configured to obtain, from the user, cancel information indicating that a scheduled power transmission/reception between the vehicle and the power grid during the scheduled period is canceled, wherein
the notification control unit is configured to notify a user of another vehicle to transmit and receive power to and from the power grid during the scheduled period if the cancel information is obtained.

15. The power transmission/reception management apparatus according to claim 1, wherein
the notification control unit is configured to cause the notification to be given to the user, when the vehicle is not enabled to transmit or receive power with the power grid at a time point earlier than the scheduled period where a predetermined time has passed since the user got off the vehicle.

16. The power transmission/reception management apparatus according to claim 3, wherein
the notification control unit is configured to determine the time point to cause the notification to be given to the user, based on the current location of the vehicle, a location information history of the vehicle, the location of the power transmission/reception facility, and the scheduled period.

17. The power transmission/reception management apparatus according to claim 3, wherein
the notification control unit is configured to determine the time point to cause the notification to be given to the user, based on a plurality of reference travel patterns specified from a location information history of the vehicle, a current travel pattern of the vehicle, the location of the power transmission/reception facility, and the scheduled period.

18. The power transmission/reception management apparatus according to claim 4, wherein
the notification control unit is configured to determine the time point to cause the notification to be given to the user, based on a plurality of reference travel patterns specified from the location information history of the vehicle, a current travel pattern of the vehicle, the location of the power transmission/reception facility, and the scheduled period.

19. The power transmission/reception management apparatus according to claim 6, wherein
the notification control unit is configured to cause the notification to be given to the user at an earlier time point, if there is no reference travel pattern among the plurality of reference travel patterns that matches the current travel pattern of the vehicle and whose destination has the power transmission/reception facility.

20. A non-transitory computer-readable storage medium having recorded thereon a program that causes a computer to perform procedures comprising:
storing information indicating a correspondence between a scheduled period during which a vehicle provided with a driving electric power source is enabled to transmit and receive power with a power grid, and the vehicle; and
causing a notification to be given to a user correlated with the vehicle, when the vehicle is not enabled to transmit or receive power with the power grid at a predetermined time point earlier than the scheduled period.
